(19) United States
(12) Patent Application Publication
(10) Pub. No.: US 2007/0280208 A1
(43) Pub. Date: Dec. 6, 2007

(54) PARTITIONED VOICE COMMUNICATION COMPONENTS OF A COMPUTING PLATFORM

(76) Inventors: Wesley H. Smith, Raleigh, NC (US); Bo Zhang, Raleigh, NC (US); Don Carmon, Raleigh, NC (US); Mark Shanahan, Raleigh, NC (US); Jeffrey A. Green, Raleigh, NC (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/421,421

(22) Filed: May 31, 2006

(51) Int. Cl. H04L 12/66

(52) U.S. Cl. 370/356

(57) ABSTRACT

Embodiments of apparatuses, articles, methods, and systems for voice communication components within a partition of a computing platform are generally described herein. Other embodiments may be described and claimed.

### FIELD

Embodiments of the present invention relate generally to the field of computer platforms, and more particularly to partitioning voice communication components within such platforms.

### BACKGROUND

Recent trends have seen migration to transporting voice traffic over data communication networks. One such instantiation is referred to as Voice over Internet Protocol (VoIP). A VoIP system transmitting voice data over a general purpose packet-switched network, as opposed to over traditional circuit-switched telephony transmission lines, may offer many benefits such as reduced cost and increased manageability. However, VoIP communication may also face challenges to provide accessible, reliable, and secure voice communication that is associated with traditional voice networks.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates a system to facilitate secure and accessible voice communications over a network in accordance with an embodiment of the present invention;

FIG. 2 illustrates a computing platform providing a dedicated partition for voice communication components in accordance with an embodiment of the present invention;

FIG. 3 illustrates a connection operation for an outgoing call in accordance with an embodiment of the present invention;

FIG. 4 illustrates a connection operation for an incoming call in accordance with an embodiment of the present invention;

FIG. 5 illustrates the computing platform in accordance with another embodiment of the present invention;

FIG. 6 illustrates dedicated and shared hardware in accordance with an embodiment of the present invention; and

FIG. 7 illustrates the computing platform utilizing virtualization technology to provide dual partitions in accordance with an embodiment of the present invention.

### DETAILED DESCRIPTION

Embodiments of the present invention may provide a method, apparatus, and system for a platform with voice communication components partitioned from a host operating system.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

In providing some clarifying context to language that may be used in connection with various embodiments, the phrase “A/B” means “A or B.” The phrase “A and/or B” means “(A), (B), or (A and B).” The phrase “A, B and/or C” means “(A), (B), (C), (A and B), (A and C), (B and C) or (A, B and C).” The phrase “(A)B” means “(B) or (A and B),” that is, A is optional.

As used herein, the term “component” is intended to refer to programming logic that may be employed to obtain a desired outcome. The term “component” may be synonymous with “module” or “agent” and may refer to programming logic that may be embodied in hardware or firmware, or in a collection of software instructions, possibly having entry and exit points, written in a programming language, such as, for example, C++.

A software component may be compiled and linked into an executable program, or installed in a dynamic link library, or may be written in an interpretive language such as BASIC. It will be appreciated that software components may be callable from other components or from themselves, and/or may be invoked in response to detected events or interrupts. Software instructions may be embedded in firmware, such as an electrically erasable programmable read-only memory (“EEPROM”), or may be stored on a readable medium such as a magnetic or optical storage device. It will be further appreciated that hardware components may be comprised of connected logic units, such as gates and flip-flops, and/or may be comprised of programmable units, such as programmable gate arrays or processors. In some embodiments, the components described herein are implemented as software modules, but nonetheless may be represented in hardware or firmware. Furthermore, although only a given number of discrete software/hardware components may be illustrated and/or described, such components may nonetheless be represented by additional components or fewer components without departing from the spirit and scope of embodiments of the invention.

In various embodiments, software components may be operated by a variety of processors (either single- or multi-core) such as, but not limited to, microprocessors, digital signal processors (“DSPs”), application specific integrated-circuits (“ASICs”), and/or controllers.

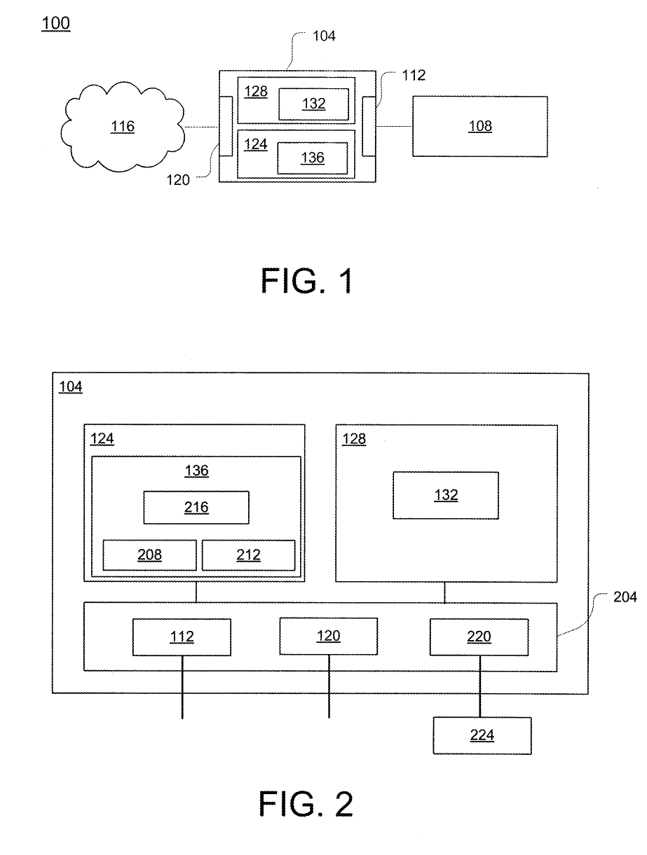

FIG. 1 illustrates a system 100 for facilitating secure and accessible voice communications over a network in accordance with an embodiment of the present invention. The system 100 may include a computing platform 104 coupled to a voice terminal 108, e.g., a telephone, which may be of an analog or digital variety, through a telephony interface such as a subscriber line interface circuit (SLIC) 112 compatible with the voice terminal 108. The coupling of the computing platform 104 to the voice terminal 108 may be referred to as the phone line, which may include physical cabling known as a local loop. In an embodiment, the SLIC 112 may be an integrated circuit to interface with the phone line to provide central office (CO) functionality to a plain old telephone service (POTS) terminal. The SLIC 112 may provide standard tip and ring signals, call progress tones, etc. for the voice terminal 108.

In various embodiments, the local loop signaling may be direct current signaling and/or in-band and out-of-band signaling (e.g., single frequency, multi-frequency, and dual-tone multi-frequency (DTMF)).

The computing platform 104 may also be coupled to a data communication network 116 through a network interface 120 for transmission/reception of packet-switched data traffic. In various embodiments, the data communication network 116 may comply with any of a number of topologies, standards, and/or protocols such as, but not limited to, transmission control protocol (TCP), Internet Protocol (IP), Real-time Transport Protocol (RTP), User Datagram Protocol (UDP), Asynchronous Transfer Mode (ATM), Frame Relay (FR), etc. In various embodiments, the data communication network 116 may comprise any type of network architecture, wired and/or wireless, including, but not limited to, a local area network (LANs), a wide area network (WAN), and/or a metropolitan area network (MAN).

The computing platform 104 may include a dedicated partition 124 and a host partition 128. The host partition 128 may include an operating system (OS) 132 to control general operation of other components of the host partition 128. The OS 132 of the host partition 128 may manage an execution environment of the host partition 128 that includes a variety of application programs accessible to the user of the computing platform 104.

While the OS 132 may provide the primary mechanism for a user to interact with the computing platform 104 it may also be associated with vulnerabilities that may compromise the components operating within the host partition 128. For example, the OS 132 may be subject to complex and evolving attacks by malware seeking to gain control of computing platform 104. These attacks can take on a variety of different forms ranging from attempts to crash the OS 132 to subversion of the OS 132 for alternate purposes. Furthermore, access provided to the OS 132, and components managed by the OS 132, may be unsuitable for certain components. Therefore, in embodiments of this invention one or more voice communication components 136 may be operated in the dedicated partition 124 secure and independent from the OS 132 of the host partition 128.

Operation of the voice communication component(s) 136 in the dedicated partition 124 may allow for security and/or accessibility configurations to be applied independently from configurations of the OS 132. The voice communication component(s) 136 may operate independently from the OS 132 and, therefore, may be referred to as being OS-agnostic. In various embodiments the voice communication component(s) 136 may sometimes be referred to as an analog terminal adapter (ATA).

The voice communication component(s) 136 operating in the dedicated partition 124 may allow for packetization and/or compression of voice traffic received from the voice terminal 108 into a protocol suitable for transporting the voice traffic in a packet-switched manner over the data communication network 116. Likewise, the voice communication component(s) 136 may also allow for the de-packetization and/or decompression of voice traffic received as packet-switched data from the network 116 for transmission to the voice terminal 108. In various embodiments, transmission/reception of voice traffic over/from the network 116 may be in the form of voice over Internet Protocol (VoIP), voice over frame relay (VoFR), etc.

In various embodiments, some of which will be discussed in further detail below, the partitions of the computing platform 104 may be provided as virtualized partitions (e.g., a virtual machine in a Virtualization Technology (VT) scheme) and/or entirely separate hardware partitions (e.g., utilizing Active Management Technologies (AMT), “Manageability Engine” (ME), Platform Resource Layer (PRL) using sequestered platform resources, System Management Mode (SMM), and/or other comparable or similar technologies). In various embodiments, a VT platform may also be used to implement AMT, ME, and/or PRL technologies.

FIG. 2 illustrates the computing platform 104 in more detail in accordance with an embodiment of this invention. The dedicated partition 124 and the host partition 128 may be coupled to one or more components of platform hardware 204. In an embodiment, the voice communication component(s) 136 of dedicated partition 124 may include a SLIC driver 208 to control operation of the SLIC 112. In an embodiment, the voice communication component(s) 136 may also include a network driver 212, e.g., a modem driver, to control operation of the network interface 120, e.g., a broadband modem such as a digital subscriber line (DSL) modem or a cable modem.

In some embodiments, the network driver 212 may be used to receive and/or transmit all of the data traffic between the network 116 and the platform 104 (in these embodiments, the network driver 212 may not be dedicated to voice communications and therefore may be separate from the voice communication component(s) 136). The network driver 212 may store data traffic from the network to the OS 132 in a shared hardware resource, e.g., shared buffers. The OS 132 may then access this data traffic via a virtual network driver operating in the host partition 128. Data traffic from the host partition 128 to the network 116 may be transmitted conversely. In other embodiments, the network driver 212 may be disposed in the host partition 128 or both partitions.

While the network interface 120 is shown as being a part of the platform hardware 204 other embodiments may have the network interface 120, or parts thereof, being external to the platform 104.

The voice communication component(s) 136 may also include one or more voice application(s) 216 coupled to the SLIC driver 208 and the network driver 212. In various embodiments, the voice application(s) 216 may include, e.g., a universal phone interface, a softphone application, a soft switch component, etc. The voice application(s) 216 may be assembled according to operation criteria of a particular embodiment. In general, the voice application(s) 216 may facilitate call processing, user input, registration, configuration, etc.

In various embodiments the platform hardware may include other input/output (I/O) interfaces 220 to communicate with one or more peripherals 224 coupled to the computing platform 104. For example, in an embodiment where the voice application(s) 216 include a softphone application, the other I/O interfaces 220 may communicate with peripheral(s) 224 such as a microphone and/or speakers to provide voice terminal functions from the computing platform 104.

While user interaction with the computing platform 104 may occur primarily through interactions with components of the host partition 128, the user may have an interrupt authority to have access to various configuration policies of the voice application(s) 216. For example, a supplicant or an agent in the host partition 128 may allow the user to invoke an interrupt to transfer control from the host OS 132 to a service OS operating in the dedicated partition 124. In other embodiments, other mechanisms may be used to provide a secured channel by which a user may configure parameters of the voice application(s) 216. User-configurable parameters of the voice application(s) 216 may include specification of leading digits to use when calling a specific country or area code, how incoming calls should be handled, etc.

Once configured, the voice application(s) 216 may be capable of operating independently from user input and transparently function to route voice communication between a remote device, i.e., a device coupled to the computing platform via the network 116, and the local voice terminal 108.

In various embodiments the OS-agnostic components of the dedicated partition 124 may be operated with a power-policy configuration that is independent from a power-policy configuration of the OS 132. For example, in an embodiment the voice communication component(s) 136 may be configured with an always-on policy or an always-on standby policy, while the user may power the OS 132 (and hardware solely supporting the OS) on/off by using, e.g., the front panel button of the computing platform 104. Therefore, regardless of the power state of the host partition 128, the voice communication component(s) 136 may be accessible for either incoming or outgoing calls.

In various embodiments, the dedicated partition 124 may include other components, e.g., management components, operating independently from the OS 132.

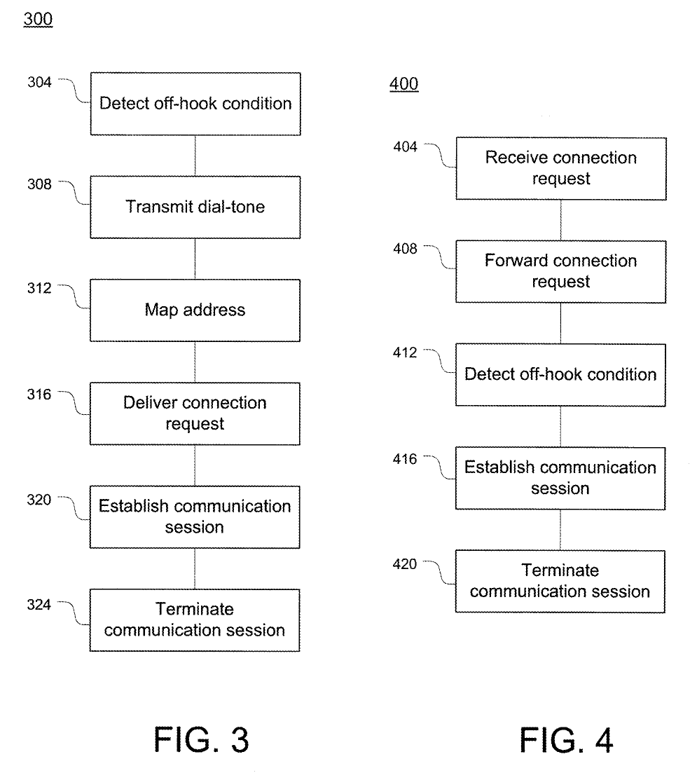

FIG. 3 illustrates a connection operation 300 for an outgoing call in accordance with an embodiment of this invention. The connection operation 300 may be initiated when an indication of an off-hook condition is received from the voice terminal 108, block 304. If the voice communication component(s) 136 are in a power-saving state, e.g., a standby mode, the detection of the off-hook condition may trigger a wake-up event. In an embodiment a wake-up event detected in the dedicated partition 124 may also be used as a trigger to wake-up one or more components in the host partition 128.

The initiated voice application(s) 216 may then transmit, via the SLIC driver 208 and the SLIC 112, a dial tone to the voice terminal 108 indicating that the voice communication component(s) 136 are ready to receive address information for the intended recipient device of the call (remote callee device), block 308.

The address information sent from the voice terminal 108 may represent a series of digits, e.g., a phone number, compatible with, e.g., a North American Numbering Plan (NANP).

The voice application(s) 216 may map the NANP address to a network address of the remote callee device, e.g., an IP address, block 312. In an embodiment an address mapping may involve a request to a call processor running a database/mapping program that may be referred to as a soft switch. In various embodiments, the soft switch may communicate with other soft switches on the network 116 in order to complete the mapping.

Upon a successful address mapping, the connection request from the computing platform 104 to the remote callee device may be delivered, block 316. If the connection request is accepted, e.g., if the callee picks up the phone, a session between the computing platform 104 and the remote callee device may be established, block 320. Data packets transporting voice traffic may be packet-switched over the network 116 between the computing platform 104 and the remote callee device. Voice traffic may be packed/unpacked by the computing platform 104 for communication with the voice terminal 108.

A session may be terminated locally at the voice terminal 108 or remotely at the remote callee device, block 324.

FIG. 4 illustrates a connection operation 400 for an incoming call in accordance with an embodiment of this invention. The connection operation may be initiated when the voice application(s) 216 receive a connection request via the network interface 120 and the network driver 212 from a remote caller device, block 404. If the voice communication component(s) 136 are in a power-saving state then the receipt of the connection request may trigger a wake-up event, regardless of the power state of the host partition 128. The voice application(s) 216 may forward the connection request to the voice terminal 108, which may be manifested through ringing at the voice terminal 108, block 408.

If a user answers the call at the voice terminal 108 an off-hook condition may be received at the computing platform 104, block 412. At the receipt of the off-hook condition, a session between the computing platform 104 and the remote caller device may be established, block 416.

A session may be terminated locally at the voice terminal 108 or remotely at the remote caller device, block 420.

While the operations discussed in FIGS. 3-4 discuss general phases involved in connection operations, various embodiments may include a number of particular supervision and address signaling sequences.

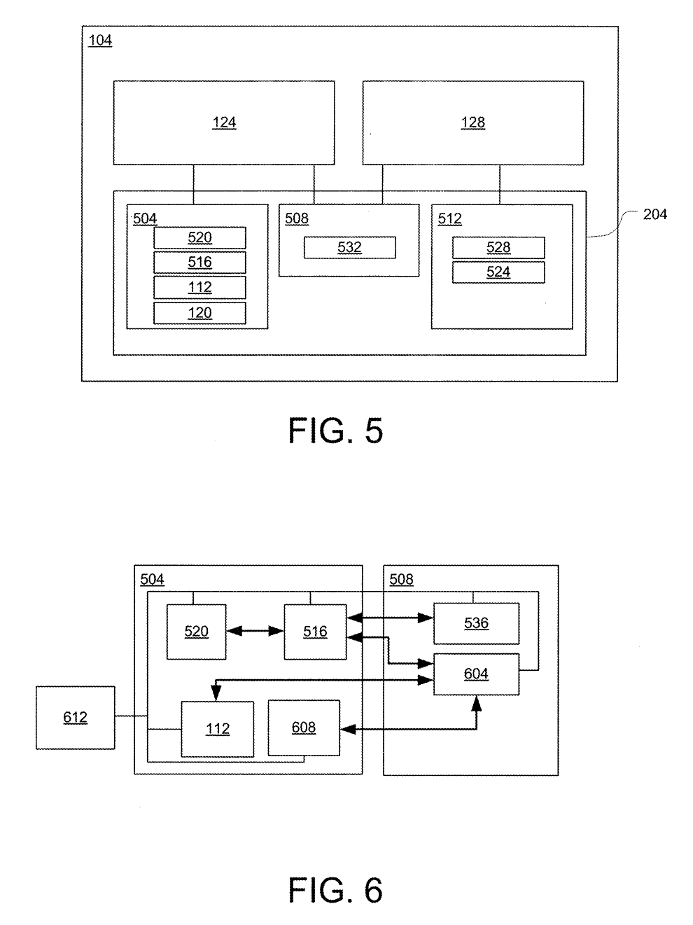

FIG. 5 illustrates the computing platform 104 in accordance with an embodiment of the present invention. In this embodiment, the platform hardware 204 may be divided into dedicated hardware 504 for components of the dedicated partition 124, host hardware 512 for components of the host partition 128, and shared hardware 508 for components of either the host partition 128 or the dedicated partition 124.

In an embodiment the dedicated hardware 504 may include the SLIC 112, a dedicated processor 516 (e.g., a service processor and/or an embedded microcontroller), dedicated memory 520, and the network interface 120; the host hardware 512 may include a host processor 524, and host memory 528; and the shared hardware 508 may include mass storage 532.

In an embodiment, mass storage 532 may represent non-volatile storage to store persistent content to be used for the operation of the components on the platform 104, such as, but not limited to, operating system(s), program files, configuration files, etc.

In various embodiments, mass storage 532 may include integrated and/or peripheral storage devices, such as, but not limited to, disks and associated drives (e.g., magnetic, optical), universal serial bus (USB) storage devices and associated ports, flash memory, ROM, non-volatile semiconductor devices, etc.

In various embodiments, mass storage 532 may be a storage resource physically part of the computing platform 104 or it may be accessible by, but not necessarily a part of, the computing platform 104. For example, the mass storage 532 may be accessed by the computing platform 104 over the network 116.

The mass storage 532 may be operationally coupled (either remotely or locally) to the dedicated processor 516 and/or the host processor 524. The content stored in the mass storage 536 may be loaded into either dedicated memory 520 or host memory 528 as active content for operation of components in the dedicated partition 124 or the host partition 128, respectively.

The dedicated processor 516 or the host processor 524 may execute the active content in respective memories to operate the components in respective partitions. In various embodiments, the processor(s) 516 and/or 524 may be single and/or multiple-core processor(s), controller(s), application specific integrated circuit(s) (ASIC(s)), etc.

In various embodiments, the dedicated memory 520 or the host memory 528 may include random access memory (RAM), dynamic RAM (DRAM), static RAM (SRAM), synchronous DRAM (SDRAM), dual-data rate RAM (DDRRAM), etc. While the embodiment shown and described in FIG. 5 relies upon hardware to provide dual partitions, other embodiments may provide dual partitions in other manners.

FIG. 6 illustrates dedicated hardware 504 and shared hardware 508 according to embodiments of the present invention. In this embodiment, the dedicated processor 516 may access persistent content of the components of the dedicated partition 124 from the mass storage 532 and place them into dedicated memory 520 as active content. The dedicated processor 516 may also be coupled to an input/output (I/O) communication hub 604 of the shared hardware 508. The I/O communication hub 604 may be coupled to the SLIC 112 and a broadband modem 608 to arbitrate data flow into and out of the computing platform 104.

In this embodiment, a power supply 612 may be coupled to the hardware components that may need to be accessed by the voice communication component(s) 136. The power supply 612 may be configured to provide these hardware components with power according to a power management policy such as an always-on policy or an always-on standby policy. This may facilitate the voice communication component(s) 136 being accessible to both incoming and outgoing calls regardless of the power state of other components.

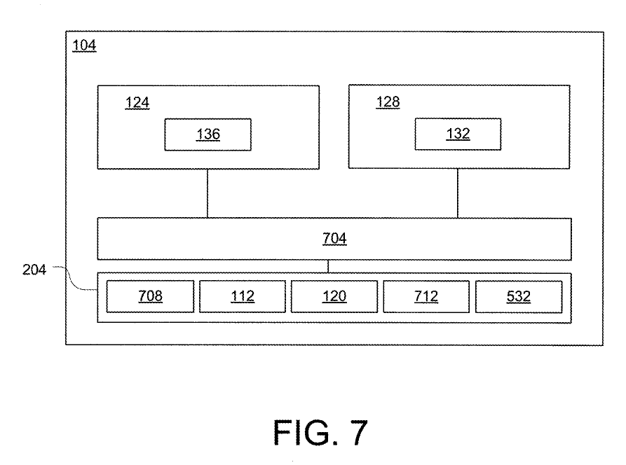

FIG. 7 illustrates the platform 104 utilizing virtualization technology (VT) to provide dual partitions in accordance with an embodiment of this invention.

In this embodiment a management module, e.g., virtual machine monitor (VMM) 704, on the platform 104 may present multiple abstractions and/or views of the platform hardware 204, e.g., one or more processor(s) 708, SLIC 112, network interface 120, memory 712, and storage 532, to the dedicated partition 124 and the host partition 128. In this embodiment, the dedicated partition 124 and the host partition 128 may also be referred to as dedicated virtual machine (VM) 124 and host VM 128, respectively. Similar to the above embodiments, the dedicated VM 124 may be configured to operate voice communication component(s) 136 independently and securely isolated from the OS 132 to prevent unauthorized operations that would alter, modify, read, or otherwise affect the voice communication component(s) 136. While the platform 104 of this embodiment shows two VMs, other embodiments may employ any number of VMs.

The components operating in the dedicated VM 124 and host VM 128 may each operate as if they were running on a dedicated computer rather than a virtual machine. That is, components operating in the dedicated VM 124 and host VM 128 may each expect to control various events and have complete access to hardware 204. The VMM 704 may manage VM access to the hardware 204. The VMM 704 may be implemented in software (e.g., as a stand-alone program and/or a component of a host operating system), hardware, firmware, and/or any combination thereof. The VMM 704 may manage allocation of resources on the computing platform 104 and perform context switching as necessary to cycle between the dedicated VM 124 and the host VM 128 according to a round-robin or other predetermined scheme. If the one or more processor(s) 708 includes multiple processors, the dedicated VM 124 may be assigned a dedicated processor while the host VM 128 may be assigned a host processor.

A physical hardware partition with a dedicated processor (as illustrated in FIG. 5, for example) may provide for a higher level of independent operation than a virtualized partition (as illustrated in FIG. 7, for example), but embodiments of the invention may be practiced in either environment and/or a combination of these environments to provide varying levels of operational independence.

Embodiments of the present invention shown and described above may facilitate partitioning of voice communication components from other components of a computing platform. Although the present invention has been described in terms of the above-illustrated embodiments, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. This description is intended to be regarded as illustrative instead of restrictive on embodiments of the present invention.

What is claimed is:

1. An apparatus comprising:
a telephony interface configured to be coupled to a voice terminal;
a processor coupled to the telephony interface; and
one or more voice communication components configured to be operated by the processor to facilitate voice communication for a host device hosting the telephony interface, the processor and the one or more voice communication components, the one or more voice communication components configured to be operated in a partition of the host device that is secure from at least an operating system of another partition of the host device.

2. The apparatus of claim 1, further comprising:
a network interface coupled to the one or more voice communication components and configured to be coupled to a data communication network to facilitate data communication for the host device.

3. The apparatus of claim 1, wherein the one or more voice communication components comprises a Voice over Internet Protocol (VoIP) component.

4. The apparatus of claim 1, wherein the one or more voice communication components of the partition are configured to operate with a power policy independent from a power policy of the operating system of the another partition.

5. The apparatus of claim 4, wherein the power policy of the one or more voice communication components is an always-on or an always-on standby power policy.

6. The apparatus of claim 1, further comprising:
another processor configured to operate the operating system in the another partition.

7. The apparatus of claim 1, wherein the partition and the another partition are implemented as a first and second virtual machine, respectively.

8. The apparatus of claim 1, wherein the telephony interface comprises a subscriber line interface circuit (SLIC).

9. The apparatus of claim 1, wherein the partition and the another partition comprise a virtual machine and another virtual machine, respectively.

10. A system comprising
a telephony interface configured to be coupled to a voice terminal;
dynamic random access memory (DRAM) configured to store content corresponding to a plurality of components including one or more voice communication components; and
a processor coupled to the telephony interface and the DRAM and configured to access the stored content to operate the plurality of components to facilitate voice communication for a host device hosting the telephony interface, the DRAM, and the processor, the plurality of components configured to be operated in a partition of the host device that is secure from at least an operating system of another partition of the host device.

11. The system of claim 10, wherein the one or more voice communication components comprises a Voice over Internet Protocol (VoIP) component.

12. The system of claim 10, wherein the one or more voice communication components of the partition are configured to operate with a power policy independent from a power policy of the operating system of the another partition.

13. The system of claim 12, wherein the power policy of the one or more voice communication components is an always-on or always-on standby power policy.

14. The system of claim 10, further comprising:
a network interface configured to be coupled to a data communication network.

15. The system of claim 14, wherein the plurality of components further includes a modem driver and the plurality of components are further configured to facilitate voice communication between a remote device coupled to the data communication network and the voice terminal via the network interface and the telephony interface, respectively.

16. The system of claim 10, wherein the telephony interface comprises a subscriber line interface circuit (SLIC).

17. A method comprising
operating an operating system in a first partition of a host device;
operating one or more voice communication components in a second partition of the host device, secure from the operating system of the first partition, to facilitate routing of voice communications between a remote device, via a network interface of the host device, and a local voice terminal, via a telephony interface of the host device.

18. The method of claim 17, further comprising:
operating the operating system with a first power policy; and
operating the one or more voice components with a second power policy, independent from the first power policy.

19. The method of claim 18, wherein the second power policy is an always-on policy or an always-on standby policy.

20. A machine accessible medium having associated instructions, which, when accessed, results in a host device:
operating one or more voice communication components in a first partition of the host device, secure from at least an operating system of another partition of the host device, to receive voice communication from a local voice terminal via a telephony interface of the host device; and
operating a network driver to transmit the voice communication to a remote device via a network interface of the host device.

21. The machine accessible medium of claim 20 having associated instructions, which, when accessed, further results in the host device:
operating the one or more voice communication components with a power policy independent from a power policy of the operating system.

22. The machine accessible medium of claim 21, wherein the second power policy is an always-on policy or an always-on standby policy.
